(19) United States
(12) Patent Application Publication
(10) Pub. No.: US 2004/0089414 A1
(43) Pub. Date: May 13, 2004

(54) Assembly method of substrates and assembly apparatus of substrates

(75) Inventors: Tsutomu Makino, Yokohama-shi (JP); Shinichi Ogimoto, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibaura Mechatronics Corporation, Yokohama-shi (JP)

(21) Appl. No.: 10/686,100

(22) Filed: Oct. 14, 2003

(30) Foreign Application Priority Data
Oct. 15, 2002 (JP) 2002-300536
Jun. 19, 2003 (JP) 2003-175023

(51) Int. Cl. B32B 31/00

(52) U.S. Cl. 156/285; 156/99; 156/382

(57) ABSTRACT

There is disclosed a method including an applying step of applying a sealing agent onto either one of two substrates, a dropping step of dropping a predetermined amount of a liquid crystal onto either one of the two substrates, a leaving step of leaving the substrate on which the liquid crystal has been dropped to stand under a reduced pressure atmosphere for a predetermined time, and a bonding step of bonding the two substrates onto each other under the reduced pressure atmosphere, after leaving the substrate on which the liquid crystal has been dropped under the reduced pressure atmosphere for the predetermined time.

### CROSS-REFERENCE TO RELATED APPLICATIONS

This application is based upon and claims the benefit of priority from the prior Japanese Patent Applications No. 2002-300536, filed Oct. 15, 2002; and No. 2003-175023, filed Jun. 19, 2003, the entire contents of both of which are incorporated herein by reference.

### BACKGROUND OF THE INVENTION

1. Field of the Invention

The present invention relates to an assembly method and an assembly apparatus for substrates, in which a liquid material is disposed between two substrates such as liquid crystal display panels to bond these to each other.

2. Description of the Related Art

As well known, during manufacturing of a liquid crystal display panel, two transparent substrates are bonded to each other at an interval of an order of μm by a sealing agent, and further a liquid crystal which is a liquid material is disposed between these substrates to assemble the substrates.

To assemble two substrates, a step of applying a peripheral portion of one substrate with the sealing agent containing a viscoelastic material, a step of dropping a predetermined amount of liquid crystal onto one or the other substrate, and a step of bonding the two substrates onto each other by the sealing agent under a reduced pressure atmosphere have heretofore been carried out.

When a gas is mixed in the sealing agent applied to the substrate, unevenness of the width of applied area and/or disconnection of the sealing agent is caused. When the gas is mixed in the liquid crystal, a drop amount becomes uneven, or bubble remains between the bonded substrates. That is, even when either the sealing agent or the liquid crystal contains the gas, defective products are caused to be produced in some case.

To solve the problem, the following is carried out so as to prevent the sealing agent applied to the substrate or the liquid crystal dropped onto the substrate from containing any gas. For example, as described in Jpn. Pat. Appln. KOKAI Publication No. 2001-174834, the substrate is deaerated before applying the sealing agent to the substrate. It has also been known that the sealing agent or the liquid crystal is deaerated. Moreover, the deaerated substrate is applied with the deaerated sealing agent and/or the deaerated liquid crystal is dropped onto the substrate.

Additionally, when a micro amount of liquid crystal is dropped drop by drop, air is sometimes easily sucked into the liquid crystal at a tip end of a nozzle dropping the liquid crystal. When the liquid crystal dropped onto the substrate is bounced and flied/scattered, the bubble is sometimes mixed in the liquid crystal.

Moreover, an inner surface of the substrate onto which the liquid crystal is dropped/supplied constitutes a concave/convex surface on which a wiring circuit is formed by a pixel electrode. Therefore, the gas is sometimes sealed as micro bubbles into a concave portion by the dropped liquid crystal, or impurities in atmospheric air sometimes adhere, and the bubbles or impurities are disposed between the substrates bonded to each other.

An object of the present invention is to provide an assembly method and assembly apparatus for substrates, in which two substrates can be bonded to each other so as to prevent any bubbles or impurities from remaining between the substrates.

### BRIEF SUMMARY OF THE INVENTION

According to the present invention, there is provided an assembly method comprising:

an applying step of applying a sealing agent onto either one of two substrates;

a dropping step of dropping a predetermined amount of a liquid material onto either one of the two substrates;

a leaving step of leaving at least the substrate on which the liquid material has been dropped in the two substrates to stand under a reduced pressure atmosphere for a predetermined time; and

a bonding step of bonding the two substrates to each other under the reduced pressure atmosphere, after leaving at least the substrate on which the liquid material has been dropped under the reduced pressure atmosphere for the predetermined time.

According to the present invention, there is provided an assembly apparatus comprising:

an applying device which applies either one of two substrates with a sealing agent;

a dropping device which drops a predetermined amount of a liquid material onto either one of the two substrates;

a pressure reduction leaving device including a first chamber to leave at least the substrate on which the liquid material has been dropped to stand under a reduced pressure atmosphere for a predetermined time; and

a bonding device including a second chamber in which the two substrates are bonded to each other under the reduced pressure atmosphere, after leaving at least the substrate on which the liquid material has been dropped under the reduced pressure atmosphere for the predetermined time.

According to the present invention, at least the substrate on which the liquid material has been dropped is left to stand under the reduced pressure atmosphere for the predetermined time, before bonding the two substrates to each other. Therefore, gas remaining on the substrate can be removed, when the two substrates are bonded to each other.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory view of an outline of an assembly apparatus according to a first embodiment of the present invention;

FIG. 2A is a schematic diagram of an applying device of a sealing agent, and FIG. 2B is a plan view a substrate applied with a sealing material;

FIG. 3A is a schematic diagram of a dropping device of a liquid crystal, and FIG. 3B is a plan view of the substrate on which the liquid crystal has been dropped;

FIG. 4 is a schematic diagram of first and second pressure reduction leaving devices;

FIG. 5A is a schematic diagram of a bonding device, and FIG. 5B is an enlarged sectional view showing a part of two substrates bonded to each other;

FIG. 6 is an explanatory view of an assembly apparatus according to a second embodiment of the present invention;

FIG. 7 is an explanatory view of an assembly apparatus according to a third embodiment of the present invention;

FIG. 8 is a schematic diagram of the bonding device which also serves as the pressure reduction leaving device;

FIGS. 9A, 9B are pressure reduction curve diagrams showing a fourth embodiment of the present invention;

FIGS. 10A, 10B are pressure reduction curve diagrams showing a fifth embodiment of the present invention;

FIGS. 11A, 11B are pressure reduction curve diagrams showing a sixth embodiment of the present invention;

FIGS. 12A, 12B are pressure reduction curve diagrams showing a seventh embodiment of the present invention; and

FIGS. 13A to 13C are pressure reduction curve diagrams showing an eighth embodiment of the present invention.

### DETAILED DESCRIPTION OF THE INVENTION

Embodiments of the present invention will hereinafter be described with reference to the drawings.

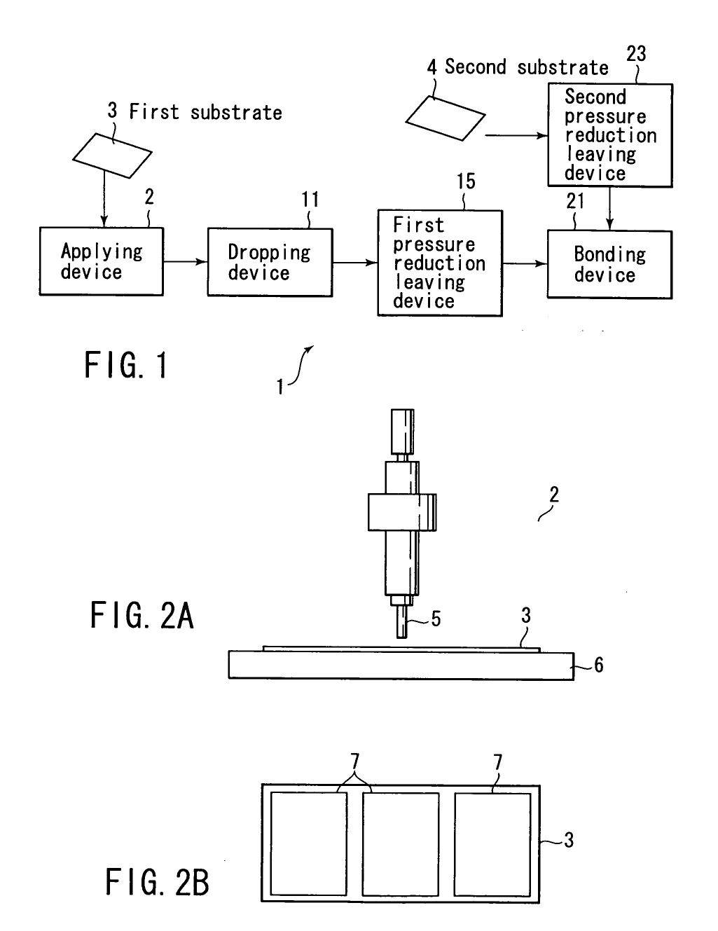

FIG. 1 shows a schematic constitution of an assembly apparatus 1 of a substrate according to a first embodiment of the present invention. This assembly apparatus 1 includes an applying device 2 of a sealing agent. One of a first substrate 3 and a second substrate 4 constituting a liquid crystal display panel, for example, the first substrate 3 is supplied to the applying device 2.

As shown in FIG. 2A, the applying device 2 includes an applying nozzle 5 driven in X, Y, and Z directions, and a first table 6 on which the first substrate 3 is supplied/laid. When the first substrate 3 is supplied onto the first table 6, the applying nozzle 5 moves downwards in the Z-direction so that a tip end of the nozzle is disposed to an upper surface (inner surface) of the first substrate 3 at a predetermined interval, and thereafter driven in the X, Y directions based on a preset coordinate. Accordingly, as shown in FIG. 2B, the first substrate 3 is applied with a sealing agent 7 in a plurality of rectangular loop shapes.

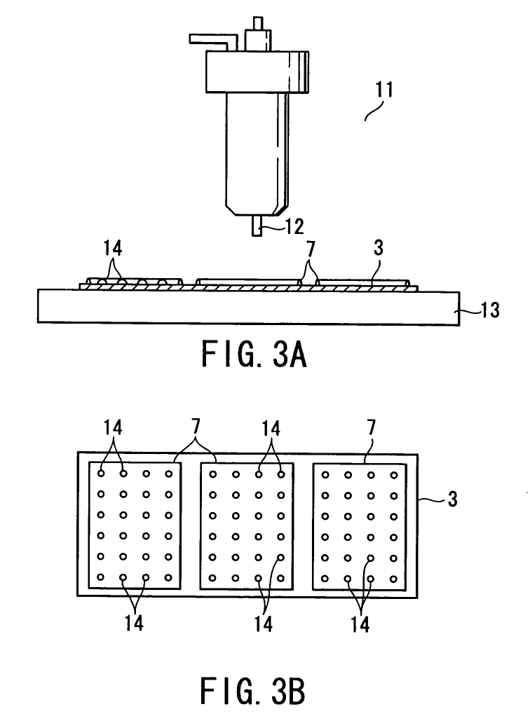

The first substrate 3 applied with the sealing agent 7 is conveyed into a dropping device 11. As shown in FIG. 3A, the dropping device 11 includes a dropping nozzle 12 and a second table 13 onto which the first substrate 3 is supplied/laid. The dropping nozzle 12 is driven in the X, Y, and Z directions.

When the first substrate 3 applied with the sealing agent 7 is supplied/laid onto the second table 13, the dropping nozzle 12 moves downwards to a predetermined height in the Z-direction, and is is thereafter driven in the X, Y directions to drop a liquid crystal 14 which is a liquid material into each rectangular frame portion surrounded by the sealing agent 7 on the inner surface of the first substrate 3. An amount of the liquid crystal 14 dropped onto the first substrate 3 is determined by an amount of droplets per drop, and the number of droplets.

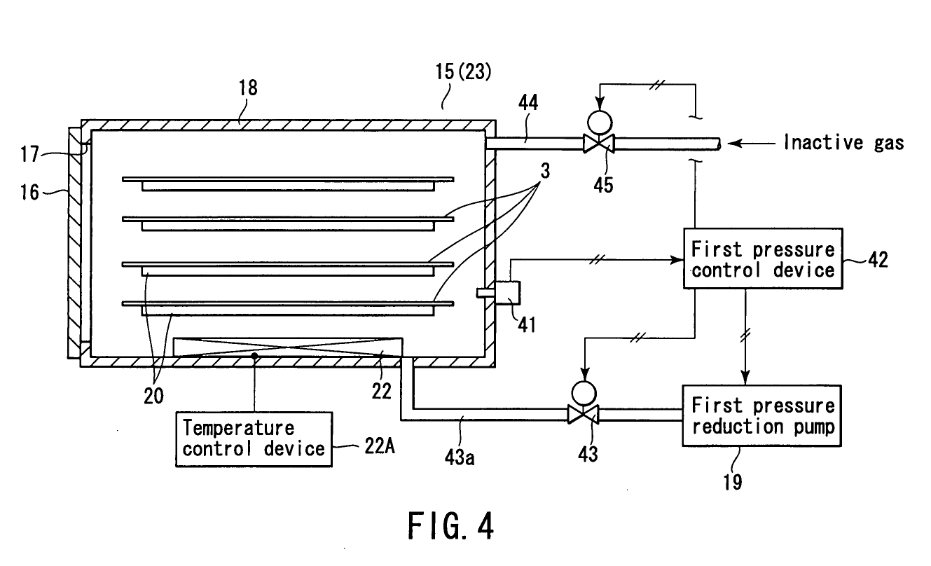

The first substrate 3 which has been applied with the sealing agent 7 and on which the liquid crystal 14 has been dropped is supplied to a first pressure reduction leaving device 15. As shown in FIG. 4, the first pressure reduction leaving device 15 includes a chamber 18 including an inlet/outlet 17 formed to be hermetically closed/sealed by a shutter 16 on one side. Inside the chamber 18, shelves 20 which support opposite ends in a width direction of the first substrate 3 are arranged at a predetermined interval in a vertical direction. Furthermore, the chamber 18 is connected to a first pressure reduction pump 19 which reduces a pressure inside the chamber to a predetermined pressure, for example, 1 Pa.

A heater 22 which is heating means is disposed in the chamber 18. In this embodiment, the heater 22 is disposed on a bottom in the chamber 18. The heater 22 is controlled by a temperature control device 22A. Accordingly, since the heater 22 is controlled, the inside of the chamber 18 can be heated at a predetermined temperature.

The pressure inside the chamber 18 is detected by a first pressure sensor 41. A detection signal of the first pressure sensor 41 is inputted into a first pressure control device 42. The first pressure control device 42 controls the pressure inside the chamber 18 based on the detection signal from the first pressure sensor 41.

That is, a first exhaust adjustment valve 43 is disposed in an exhaust pipe 43a which connects the chamber 18 to the first pressure reduction pump 19, and this exhaust adjustment valve 43 is controlled to open/close in response to the detection signal from the pressure sensor 41. Accordingly, when the pressure in the chamber 18 is lowered, it is possible to control a pressure reduction curve indicating a relation between time and pressure inside the chamber 18.

When the pressure in the chamber 18 is reduced/controlled, the driving of the first pressure reduction pump 19 may also be controlled by the first pressure control device 42. However, it is preferable to bring the first pressure reduction pump 19 into an operative state and to control the pressure in the chamber 18 by the opening/closing of the exhaust adjustment valve 43.

Furthermore, the chamber 18 is connected to a first inactive gas supply pipe 44 which supplies an inactive gas set at a predetermined pressure from a supply source (not shown). The first inactive gas supply pipe 44 includes a first supply adjustment valve 45. This first supply adjustment valve 45 is controlled to open/close based on the detection signal from the pressure sensor 41 by the first pressure control device 42. Accordingly, when the pressure in the chamber 18 is increased, it is possible to control a pressure rise curve indicating the relation between time and pressure in the chamber 18.

The first substrate 3 is left to stand in the chamber 18 of the first pressure reduction leaving device 15 whose pressure has been reduced to 1 Pa for a predetermined time, for example, for one hour, and thereafter supplied to a bonding device 21 of the next step. That is, when the first substrate 3 is left to stand in the first pressure reduction leaving device 15 for the predetermined time, the gas contained in the sealing agent 7 applied to the first substrate 3, the gas contained in the liquid crystal 14 dropped onto the first substrate 3, and bubbles or impurities adhering to a plate surface of the first substrate 3 can be removed.

On the other hand, the second substrate 4 is supplied to a second pressure reduction leaving device 23. The second pressure reduction leaving device 23 has the same constitution as that of the first pressure reduction leaving device 15 shown in FIG. 4. Moreover, the second substrate 4 is supplied into the chamber 18 of the second pressure reduction leaving device 23, and the pressure in the chamber 18 is reduced, for example, to 1 Pa which is the predetermined pressure. Thereafter, the substrate is left to stand for the predetermined time, for example, for one hour, and then supplied to the bonding device 21. Accordingly, the bubbles or impurities adhering to the plate surface of the second substrate 4, especially the inner surface having a concave/convex shape because a pixel electrode, and the like are disposed, that is, the surfaces disposed opposite to each other, when a pair of substrates 3, 4 are bonded to each other are removed.

Furthermore, since the heaters 22 are disposed in the first and second pressure reduction leaving devices 15, 23, these substrates can be heated at a predetermined temperature, when leaving the substrates 3, 4 to stand at the reduced pressure. Accordingly, when the substrates 3, 4 are heated, it is possible to effectively remove the adhering impurities such as moisture that is easily removed. At this time, temperature control in which temperature characteristics of the material such as a thermosetting characteristic of the sealing agent 7 are considered is carried out by the control device 22A.

It is to be noted that when the first and second substrates 3, 4 are left to stand under the predetermined reduced pressure in the first and second pressure reduction leaving devices 15, 23 for the predetermined time, the pressure in the chamber 18 may also immediately be raised. Alternatively, after the reduced pressure is maintained as such, the pressure may also be raised. Moreover, to raise the pressure, the inactive gas may also be supplied to raise the pressure gradually or in a predetermined pressure rise pattern.

Various controls by the temperature control devices 22A and first pressure control devices 42 disposed in the first and second pressure reduction leaving devices 15, 23, respectively, can be carried out by one control device.

The first substrate 3 left to stand under the reduced pressure atmosphere of the first pressure reduction leaving device 15 for the predetermined time is bonded to the second substrate 4 left to stand under the reduced pressure atmosphere of the second pressure reduction leaving device 23 for the predetermined time by the bonding device 21.

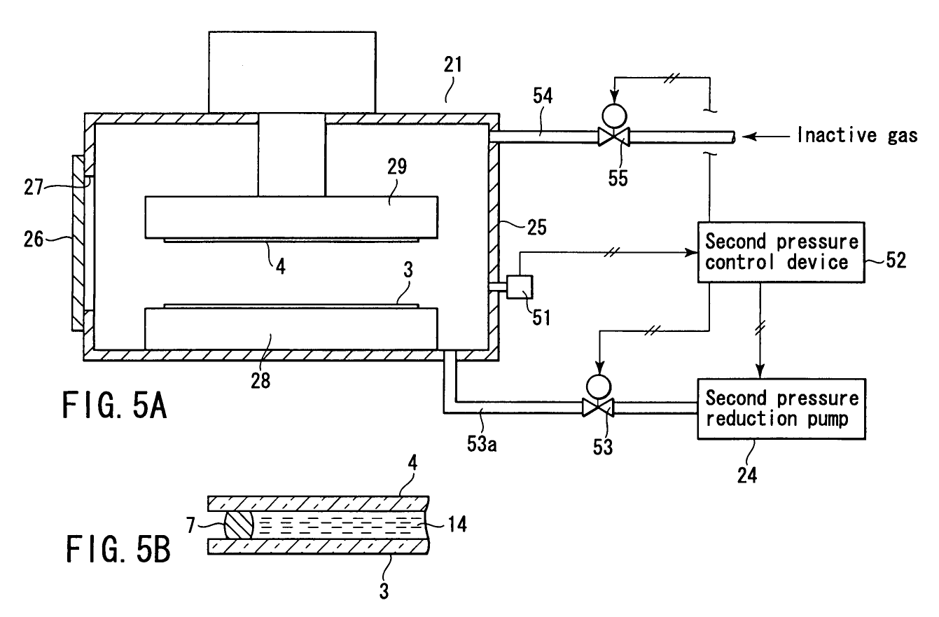

As shown in FIG. 5A, the bonding device 21 includes a chamber 25 whose pressure is reduced by a second pressure reduction pump 24, and an inlet/outlet 27 is formed to be opened/closed by a shutter 26 on one side of the chamber 25.

In the chamber 25, a table 28 driven in X, Y, and θ directions is disposed, and a chuck 29 driven in the Z-direction is disposed above the table 28. On the table 28, the first substrate 3 is laid/held with the inner surface of the substrate directed upwards. On the chuck 29, the outer surface (upper surface) of the second substrate 4 is attracted, and the inner surface is accordingly directed downwards and held.

The pressure in the chamber 25 is detected by a second pressure sensor 51. The detection signal of the second pressure sensor 51 is inputted into a second pressure control device 52. The second pressure control device 52 controls the pressure in the chamber 25 based on the detection signal from the second pressure sensor 51.

That is, a second exhaust adjustment valve 53 is disposed in an exhaust pipe 53a which connects the chamber 25 to the second pressure reduction pump 24, and this exhaust adjustment valve 53 is controlled to open/close in response to the detection signal from the pressure sensor 51. Accordingly, when the pressure in the chamber 25 is lowered, it is possible to control the pressure reduction curve indicating the relation between time and pressure in the chamber 25.

When the pressure in the chamber 25 is reduced/controlled, the driving of the second pressure reduction pump 24 may also be controlled by the second pressure control device 52. However, it is preferable to bring the second pressure reduction pump 24 into the operative state and to control the pressure in the chamber 25 by the opening/closing of the exhaust adjustment valve 53.

Furthermore, the chamber 25 is connected to a second inactive gas supply pipe 54 which supplies the inactive gas pressurized at a predetermined pressure from the supply source (not shown). The second inactive gas supply pipe 54 includes a second supply adjustment valve 55. This second supply adjustment valve 55 is controlled to open/close based on the detection signal from the pressure sensor 51 by the second pressure control device 52. Accordingly, when the pressure in the chamber 25 is increased, it is possible to control the pressure rise curve indicating the relation between time and pressure in the chamber 25.

When the first substrate 3 and second substrate 4 are supplied to the chamber 25 of the bonding device 21, and after the inlet/outlet 27 of the chamber 25 is hermetically closed/sealed by the shutter 26, the pressure in the chamber 25 is reduced to the predetermined pressure by the second pressure reduction pump 24. The pressure reduction curve at this time, that is, the relation between the pressure and time in the chamber 25 can be set by the second pressure control device 52.

Additionally, after the first substrate 3 is positioned with respect to the second substrate 4 in the X, Y, and θ directions, the second substrate 4 moves downwards and is pressed with respect to the first substrate 3 at the predetermined pressure. Accordingly, as shown in FIG. 5B, the first substrate 3 is bonded/fixed to the second substrate 4 at an interval of an order of μm by the sealing agent 7.

The first substrate 3 and second substrate 4 are left to stand under a predetermined reduced pressure atmosphere for the predetermined time by the first pressure reduction leaving device 15 and second pressure reduction leaving device 23, before bonded to each other by the bonding device 21.

Therefore, even when the sealing agent 7 or liquid crystal 14 disposed on the first substrate 3 contains gas, or the bubbles or impurities adhere to the plate surface of the first substrate 3, the gas or impurities are removed from the first substrate 3 left to stand under the reduced pressure atmosphere of the first pressure reduction leaving device 15 for the predetermined time.

Similarly, even when the bubbles or impurities adhere to the plate surface of the second substrate 4 including no sealing agent 7 or liquid crystal 14, the gas or impurities are removed from the second substrate 4 left to stand under the reduced pressure atmosphere of the second pressure reduction leaving device 23 for the predetermined time.

Therefore, the bubbles or impurities can be prevented from being disposed between the first substrate 3 and second substrate 4 bonded to each other by the bonding device 21, and it is therefore possible to assemble the liquid crystal display panel which does not cause display defect.

It is to be noted that after bonding the first and second substrates 3 and 4 are bonded to each other under the predetermined reduced pressure in the chamber 25 of the bonding device 21, the pressure in the chamber 25 may also immediately be raised. Alternatively, the pressure may be maintained for the predetermined time and may then raised. The pressure in the chamber 25 may be raised in a predetermined pattern by supplying inert gas into the chamber 25. To raise the pressure in the chamber 25, a second supply adjustment valve 55 can be controlled to open/close by the second pressure control device 52 to set the pressure rise pattern.

In the first embodiment, the first and second substrates 3, 4 deaerated by the first pressure reduction leaving device 15 and second pressure reduction leaving device 23 are taken out of these pressure reduction leaving devices 15, 23 and supplied to the bonding device 21.

Therefore, the respective substrates 3, 4 are exposed to the atmospheric air before supplied to the bonding device 21. However, the substrates 3, 4 are bonded to each other by the bonding device 21 immediately after the substrates are taken out of the pressure reduction leaving devices 15, 23, that is, before the bubbles or impurities adhere to the substrates again to such an extent that problems occur in qualities. Then, the bubbles or impurities can be prevented from adhering to these substrates 3, 4. This can be achieved, for example, by supplying the first and second substrates 3, 4 directly to the bonding device 21 without subjecting the substrates to any production step.

The first and second pressure reduction leaving devices 15, 23 include the heaters 22. Therefore, it is possible to effectively remove the impurities adhering to the respective substrates 3, 4, such as moisture that easily evaporates by heat.

It is to be noted that the heater 22 may also be disposed in either one of the first and second pressure reduction leaving devices 15, 23.

The first and second pressure reduction leaving devices 15, 23 for leaving the substrates 3, 4 to stand at the reduced pressure are disposed separately from the bonding device 21 which bonds the substrates 3, 4 to each other. Therefore, since the substrates 3, 4 can be left to stand at the reduced pressure simultaneously with the bonding, productivity can be enhanced.

The first and second pressure reduction leaving devices 15, 23 can be operated at a pressure which is different from that of the bonding device 21. Therefore, since the substrates 3, 4 can be left to stand and bonded to each other at appropriate pressures, respectively, the qualities of products can be enhanced.

It is to be noted that although not shown, to supply the substrates 3, 4 to the chamber 25 of the bonding device 21 from the pressure reduction leaving devices 15, 23 without exposing the substrates to the atmospheric air, two inlets and one outlet (not shown) for the substrates are disposed in the bonding device 21, and the inlet and outlet (not shown) for the substrate are disposed in each of the first and second pressure reduction leaving devices 15, 23.

Two inlets of the bonding device 21 are connected to the outlets (not shown) of the first and second pressure reduction leaving devices 15, 23, respectively, via a transfer chamber in which a transfer robot is disposed. Moreover, the transfer robot supplies the substrates 3, 4 to the bonding device 21 whose pressure has been reduced by the second pressure reduction pump 24 from the respective pressure reduction leaving devices 15, 23 via the transfer chamber. Accordingly, the substrates 3, 4 can be prevented from being exposed to the atmospheric air.

Openable/closable shutters for maintaining spaces of the chambers in an airtight manner are disposed between the chambers 18 of the pressure reduction leaving devices 15, 23 and the transfer chamber and between the transfer chamber and the chamber 25 of the bonding device 21. Moreover, the transfer chamber is constituted such that the pressure can be controlled. Accordingly, the pressures in the chambers 18 of the pressure reduction leaving devices 15, 23, the transfer chamber, and the chamber 25 of the bonding device 21 can individually be controlled.

Therefore, for example, even when the substrates 3, 4 bonded to each other are taken out of the chamber 25 of the bonding device 21, the inside of the chambers 18 of the pressure reduction leaving devices 15, 23 and that of the transfer chamber can be maintained in the reduced pressure atmosphere, and therefore the substrates 3, 4 in the pressure reduction leaving devices 15, 23 can be prevented from being exposed to the atmospheric air. Furthermore, the pressure of the bonding device 21 can be reduced separately from the pressure reduction leaving devices 15, 23, the substrates can be left to stand at the reduced pressure in a step different from that of bonding the substrate onto each other, and it is therefore possible to efficiently assemble the substrates.

The transfer chambers whose pressure can be controlled may also be disposed in the inlets through which the substrates 3, 4 are taken into the first pressure reduction leaving device 15 and second pressure reduction leaving device 23, and the outlet for taking out the substrates of the bonding device 21. Then, when the substrates are taken into the respective pressure reduction leaving devices 15, 23, or when the substrates bonded to each other are removed from the bonding device 21, reduced pressure states of the chambers 18, 25 of the respective devices 15, 23, 21 can be maintained, and therefore the productivity can further be enhanced.

In the first embodiment, the heaters 22 for heating the substrates 3, 4 are disposed in the first and second pressure reduction leaving devices 15, 23, but the heater 22 may also be disposed in the bonding device 21 or either one of the table 28 and chuck 29.

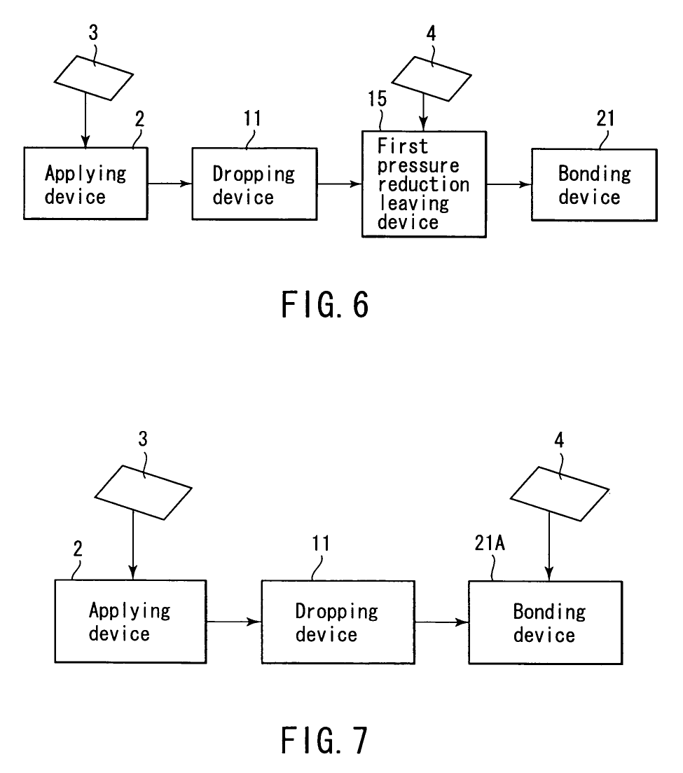

FIG. 6 shows a second embodiment of the present invention. In the first embodiment, the second substrate 4 is left to stand under the reduced pressure atmosphere of the second pressure reduction leaving device 23 for the predetermined time. However, in the second embodiment shown in FIG. 6, the second substrate 4 is left to stand under the reduced pressure atmosphere of the first pressure reduction leaving device 15 together with the first substrate 3 for the predetermined time, and may then be supplied to the bonding device 21.

Accordingly, the second pressure reduction leaving device 23 used in the first embodiment is not required, and it is therefore possible to miniaturize the apparatus.

It is to be noted that in the second embodiment, the second substrate 4 may also be supplied directly to the bonding device 21 without leaving the substrate to stand under the reduced pressure atmosphere of the first pressure reduction leaving device 15 for the predetermined time. Since the sealing agent 7 or the liquid crystal 14 is not disposed on the second substrate 4, an amount of adhering gas is small at the bonding as compared with the first substrate 3. Therefore, when the impurities such as the gas adhering to the second substrate 4 are in a level having no problem in products, the second substrate 4 may also be bonded without being left to stand under the reduced pressure atmosphere.

Moreover, the heater is disposed in either the first pressure reduction leaving device 15 or the bonding device 21, and the substrates 3, 4 are heated before bonded to each other, so that the impurities such as moisture may also efficiently be removed.

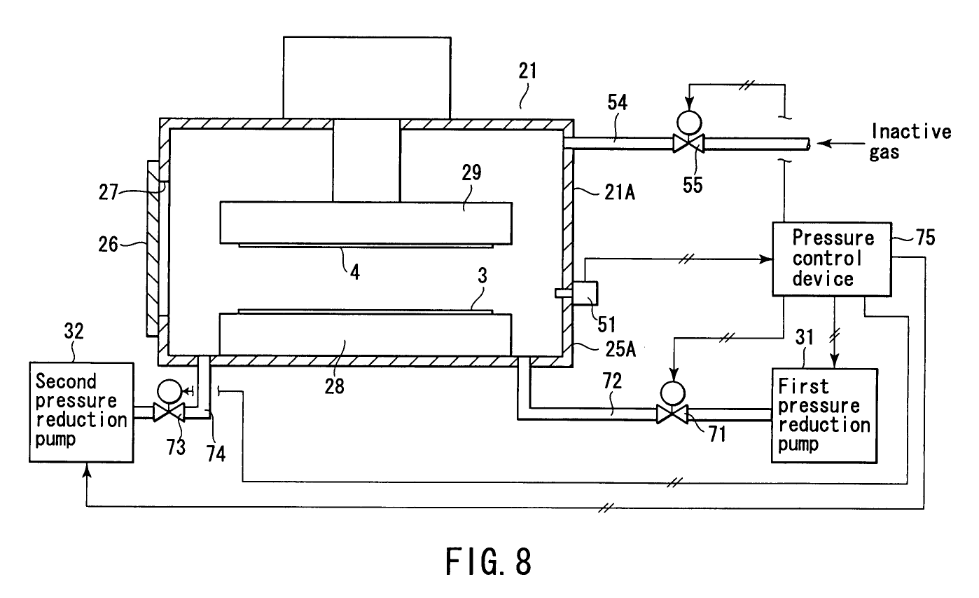

FIGS. 7 and 8 show a third embodiment of the present invention. In this embodiment, a bonding device 21A also serves as the first pressure reduction leaving device 15 and second pressure reduction leaving device 23. That is, the first substrate 3 which has been applied with the sealing agent 7 by the applying device 2 and onto which the liquid crystal 14 has been dropped by the dropping device 11 is supplied to the table 28 of the bonding device 21A. Moreover, the second substrate 4 is supplied/held onto the chuck 29 of the bonding device 21A.

Since the bonding device 21A includes substantially the same constitution of the bonding device 21 shown in FIG. 5, the same components are denoted with the same reference numerals, and the description is omitted. That is, a chamber 25A is connected to not only a first pressure reduction pump 31 which is first pressure reduction means but also a second pressure reduction pump 32 which is second pressure reduction means. The first pressure reduction pump 31 is different from the second pressure reduction pump 32 in a pressure range in which the pressure in the chamber 25A is reduced. In this embodiment, the pressure in the chamber 25A can be reduced to be lower by the second pressure reduction pump 32 rather than the first pressure reduction pump 31.

The first pressure reduction pump 31 is connected to the chamber 25A via a first exhaust pipe 72 including a first exhaust adjustment valve 71, and the second pressure reduction pump 32 is connected to the chamber 25A via a second exhaust pipe 74 including a second exhaust adjustment valve 73.

The detection signal of the pressure sensor 51 for detecting the pressure in the chamber 25A is inputted into a control device 75. The control device 75 controls each valve 55, 71, 73 to open/close based on the detection signal from the pressure sensor 51.

When the first and second substrates 3, 4 are supplied to the chamber 25A, the pressure of the chamber 25A is first reduced to a predetermined pressure by the first pressure reduction pump 31. The first and second substrates 3, 4 are left to stand in this state, that is, under the predetermined reduced pressure atmosphere for the predetermined time.

Accordingly, the gas included in the applying sealing agent 7 or dropped liquid crystal 14 with respect to the first substrate 3 is removed. Additionally, when the bubbles adhere to the plate surfaces of the first and second substrates 3, 4 having concave/convex shapes, these bubbles are also removed, and further the impurities are also removed.

Next, when the second pressure reduction pump 32 reduces the pressure in the chamber 25A to a pressure lower than that reduced by the first pressure reduction pump 31, the second substrate 4 is positioned with respect to the first substrate 3, and the substrate 4 is further moved downwards and pressed onto the first substrate 3 via the sealing agent 7. Accordingly, the first and second substrates 3, 4 can be assembled without any gas between the substrates.

In this manner, the pressure of the chamber 25A is reduced to the predetermined pressure before the first and second substrates 3, 4 are bonded to each other in the chamber 25A of the bonding device 21, and the substrates 3, 4 are left to stand under the reduced pressure atmosphere for the predetermined time.

Therefore, even when the gas is included in the applying sealing agent 7 and the dropped liquid crystal with respect to the first substrate 3, or the bubbles or impurities adhere to the plate surfaces of the first and second substrates 3, 4, these are removed before bonding the second substrate 4 to the first substrate 3 via the sealing agent 7. Therefore, the liquid crystal display panel can be assembled without disposing the gas between the first substrate 3 and second substrate 4.

In the chamber 25A the first and second substrates 3, 4 are left to stand under the predetermined reduced pressure atmosphere for the predetermined time, and are then bonded to each other. Therefore, since the substrates 3, 4 left to stand under the reduced pressure atmosphere for the predetermined time can be bonded to each other without being exposed to the atmospheric air, it is possible to prevent the gas from existing between the substrates 3, 4 with a higher accuracy as compared with a case in which the substrates 3, 4 are left to stand and bonded to each other in separate chambers.

When the liquid crystal 14 is left to stand under a pressure lower than the predetermined pressure for a long time, some of components sometimes evaporate from the liquid crystal 14 to deteriorate capabilities depending on the type of the liquid crystal. Therefore, in the present embodiment, the reduced pressure at the time at which the first and second substrates 3, 4 are left to stand is set to such a pressure that some of components are prevented from evaporating from the liquid crystal 14 and that the capabilities of the liquid crystal 14 are not prevented from being deteriorated by the first pressure reduction pump 31. At the time at which the substrates are bonded to each other, the pressure under the reduced pressure atmosphere is set to be lower than that at the time at which the substrates are left to stand.

Therefore, even with the use of the liquid crystal 14 having a possibility that some of the components evaporate under a low pressure, the first substrate 3 on which the liquid crystal 14 has been dropped is left to stand under the reduced pressure atmosphere for the long time for the deaeration. Even in this case, predetermined components can be prevented from evaporating from the liquid crystal 14 and the capabilities of the liquid crystal 14 can be prevented from being deteriorated.

The pressure at the time at which the first and second substrates 3, 4 are left to stand under the reduced pressure in the chamber 25A may also be the same as that at the time at which the substrates are bonded to each other. In this case, it is preferable to set the pressure to such a pressure that some of the components are prevented from evaporating from the liquid crystal 14 and that the capabilities are prevented from being deteriorated.

It is to be noted that it is further preferable to also consider the time for which the substrates 3, 4 are left to stand under the reduced pressure atmosphere. For example, the time when the substrates are left to stand is set to optimum conditions based on the characteristics of the liquid crystal or the sealing agent.

The substrates 3, 4 are left to stand at the reduced pressure and are bonded to each other in one chamber 25A of the bonding device 21A. Therefore, as compared with a case where the operations are carried out in the separate chambers, there is an advantage that the assembly apparatus can be miniaturized.

When the first and second substrates 3, 4 are deaerated in the chamber 25A of the bonding device 21A for the predetermined time, for example, for about one hour, a tact time sometimes lengthens. Therefore, to shorten the tact time, a plurality of bonding devices 21A may also be juxtaposed downstream from the dropping device 11.

Even in this third embodiment, the heaters may be disposed in the chamber 25A or on the table 28 or the chuck 29 to heat the substrates 3, 4, when the substrates are left to stand. Accordingly, the impurities that easily evaporate, such as the moisture adhering to the substrates, may efficiently be removed.

Furthermore, in the bonding device 21A of the third embodiment, in the same manner as in the pressure reduction leaving device or the bonding device of the first embodiment, the chamber 25A is connected to the first and second pressure reduction pumps via the exhaust adjustment valve to control a pressure reduction pattern in the chamber. Alternatively, a supply tube of the inactive gas may also be connected to the chamber via the supply adjustment valve to control a pressure rise pattern in the chamber.

When the first and second substrates are left to stand in the chamber of the pressure reduction leaving device, the pressure reduction curve in the chamber is set by deaeration characteristics of the member disposed in the chamber, that is, each substrate, the liquid crystal which is the liquid material disposed on either substrate, and the sealing agent disposed on either substrate. The deaeration characteristics are determined by a degree of vacuum and a leaving time in the chamber which are optimum for deaerating the members such as the substrates, liquid crystal, and sealing agent.

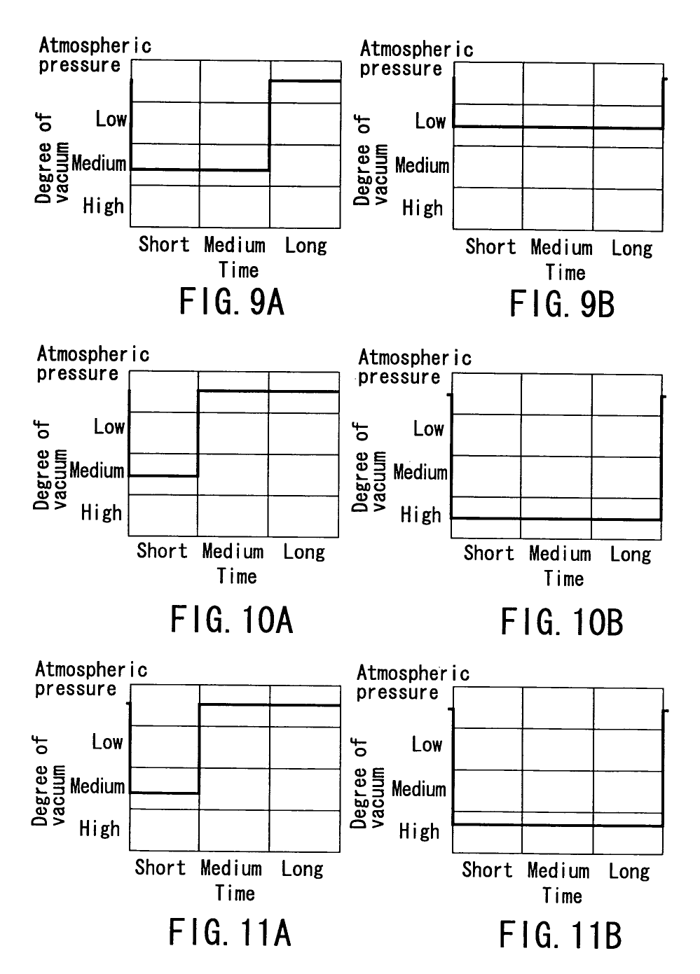

FIGS. 9 to 13 show deaeration curves determined by the deaeration characteristics of the respective members in fourth to eighth embodiments of the present invention. The deaeration characteristics of the respective members in the fourth embodiment are shown in the following Table 1. The first substrate is usually formed of the same material as that of the second substrate. However, when circuit patterns such as thin film transistors or orientation films formed on the respective substrates differ, the deaeration characteristics differ.

TABLE 1

| | Optimum degree | Optimum |
|---|---|---|
| Member | of vacuum | leaving time |
| First substrate | Medium | Medium |
| Second substrate | Low | Long |
| Liquid crystal | Medium | Medium |
| Sealing agent | Low | Long |

In the members having the deaeration characteristics shown in the above Table 1, the liquid crystal was disposed on the first substrate, and the sealing agent was disposed on the second substrate. The pressures of the respective substrates are reduced under the separate reduced pressure atmospheres, that is, in the separate chambers. FIG. 9A shows the pressure reduction curve of the first substrate, and FIG. 9B shows the pressure reduction curve of the second substrate.

In Table 1 and FIGS. 9A, 9B, “a high degree of vacuum” indicates a pressure of 1.0 Pa or less, “a medium degree of vacuum” indicates a pressure of 10 to 1.0 Pa, and “a low degree of vacuum” indicates a pressure to the atmospheric pressure to 10 Pa.

Assuming that the first substrate and liquid crystal have the medium degree of vacuum, and the medium leaving time, and the second substrate and sealing agent have the low degree of vacuum and the long leaving time, these members can be reduced in the pressure and left to stand with the optimum degree of vacuum and leaving time. Therefore, it is possible to securely deaerate the respective members.

In the pressure reduction curves of FIGS. 9A, 9B, after the pressure reduction, the pressure in the chamber is returned to an atmospheric pressure. However, one chamber is connected to the other chamber directly or using a connection chamber in the airtight manner, and further after the deaeration, two substrates are bonded to each other in one of two chambers. In this case, after the deaeration, the pressure does not have to be raised to the atmospheric pressure in the chamber where the substrates are bonded to each other. Therefore, the bonding operation can efficiently be carried out.

In the fifth embodiment, as shown in the following Table 2, the liquid crystal differs in the deaeration characteristics for each type.

TABLE 2

| | Optimum degree | Optimum leaving |
|---|---|---|
| Member | of vacuum | time |
| Low-viscosity | Medium | Short |
| liquid crystal | | |
| High-viscosity | High | Long |
| liquid crystal | | |

For example, in recent years, for a liquid crystal television set, for the enhancement of image quality at the time of dynamic image display, a low-viscosity liquid crystal having good response has been used as compared with a conventional liquid crystal. In general, the low-viscosity liquid crystal contains a volatile material. Therefore, the liquid crystal is left to stand under the reduced pressure atmosphere of the high degree of vacuum for the long time, volatile components evaporate from the liquid crystal, and this causes a display defect of a liquid crystal display. Therefore, with such liquid crystal, it is necessary to set the pressure reduction curve in such a manner that the liquid crystal is prevented from being left to stand under the reduced pressure atmosphere of the high degree of vacuum for the long time.

FIGS. 10A, 10B show the pressure reduction curves of the liquid crystals of types shown in Table 2, FIG. 10A shows the deaeration of a low-viscosity liquid crystal, and FIG. 10B shows the deaeration of a high-viscosity liquid crystal. That is, the low-viscosity liquid crystal can be deaerated in a short time, and much time is required for deaerating the high-viscosity liquid crystal.

Therefore, assuming that the low-viscosity liquid crystal has the pressure reduction curve shown in FIG. 10A and the high-viscosity liquid crystal has the pressure reduction shown in FIG. 10B, even if the liquid crystals have the low or high viscosity, these liquid crystals can securely be deaerated. Additionally, since the leaving (deaerating) pressure of the low-viscosity liquid crystal is set to be “medium”, and the time is set to be “short”, the volatile components can be prevented from coming off the low-viscosity liquid crystal.

FIGS. 11A, 11B, and the following Table 3 show a sixth embodiment of the present invention. Table 3 shows the deaeration characteristics in a case where the amount of droplets per one drop of the liquid crystal is reduced and the number of drops is increased and in a case where the amount of droplets per drop is increased and the number of drops is reduced. As apparent from this Table 3, when the amount of droplets per drop decreases, the droplets become small. Therefore, as compared with the large amount of droplets per drop, the degree of vacuum required for the deaeration can be lowered, and the leaving time can be shortened. It is to be noted that when the same amount of the liquid crystal is supplied to the substrate, the number of drops increases in the case where the amount of droplets per drop is decreased. The number of drops decreases in the case where the amount of droplets per drop is increased.

TABLE 3

| Amount of | | Optimum | Optimum |
|---|---|---|---|
| droplets per | Number of | degree of | leaving |
| drop | drops | vacuum | time |
| Small | Large | Medium | Short |
| Large | Small | High | Long |

FIG. 11A shows the pressure reduction curve in a case where the amount of droplets of the liquid crystal per drop is small, that is, the droplets are small. FIG. 11B shows the pressure reduction curve in a case where the amount of droplets of the liquid crystal per drop is large, that is, the droplets are large. When the amount of droplets of the liquid crystal per drop is small, the droplets can be deaerated at a low pressure and in a short time as compared with the case where the amount is large.

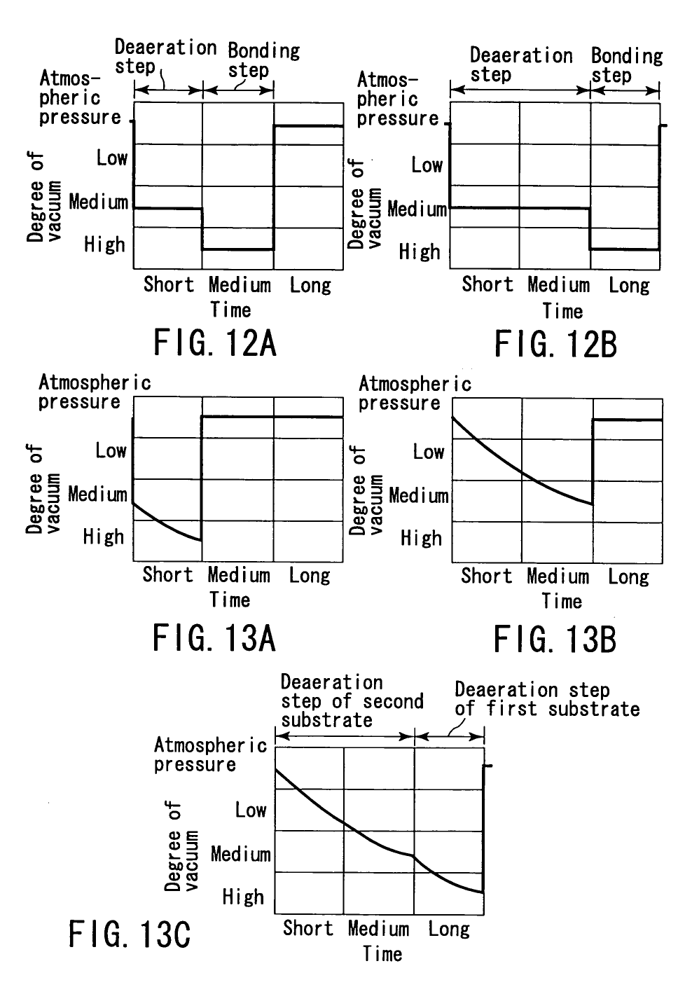

FIGS. 12A, 12B show a seventh embodiment of the present invention. In this embodiment, when the same amount of the liquid crystal is supplied to the substrates, and the substrates are deaerated and bonded to each other, the amount of the supplied liquid crystal per drop and the number of drops are set to be different. That is, in FIG. 12A, the amount of droplets per one drop of the liquid crystal is decreased, and the number of droplets is increased. In FIG. 12B, the amount of droplets per one drop of the liquid crystal is increased, and the number of droplets is decrease.

Even when both the degrees of vacuum are set to the same “medium degree of vacuum” in this manner, an appropriate leaving time is set in accordance with the amount of droplets per drop of the liquid crystal, and accordingly the deaeration can securely be carried out. Therefore, when the number of drops is increased and the amount of droplets per drop of the liquid crystal is decreased as shown in FIG. 12A, a time required for the deaerating step can be shortened as compared with the case where the number of drops is decreased and the amount of droplets per drop is increased as shown in FIG. 12B. Therefore, a total step time of the deaerating step and bonding step shortens, and the productivity can therefore be enhanced.

FIGS. 13A to 13C and the following Table 4 show an eighth embodiment of the present invention. Table 4 shows the deaeration characteristics of the first and second substrates, liquid crystal, and sealing agent, which are different from those of Table 1.

TABLE 4

| | Optimum degree | | Optimum |
|---|---|---|---|
| Member | of vacuum | | leaving time |
| First substrate | Medium to | high | Short |
| Second substrate | Low to | medium | Medium |
| Liquid crystal | Medium to | high | Short |
| Sealing agent | Low to | medium | Medium |

When the respective members have the deaeration characteristics shown in Table 4, the liquid crystal is disposed on the first substrate, and the sealing agent is disposed on the second substrate. In this case, the optimum degree of vacuum of the first substrate and liquid crystal is from “medium” to “high”, the deaerating time which is the leaving time is “short”, and therefore the substrate and liquid crystal are preferably deaerated based on the pressure reduction curve shown in FIG. 13A.

The optimum degree of vacuum of the second substrate and sealing agent is from “low” to “medium”, the deaerating time which is the leaving time is “medium”, and therefore the substrate and liquid crystal are preferably deaerated based on the pressure reduction curve shown in FIG. 13B.

The first and second substrates are sometimes requested to be deaerated in the same chamber. In this case, the pressure in one chamber in which the first and second substrates are disposed is reduced based on the pressure reduction curve shown in FIG. 13C, and then the members such as the first and second substrates, liquid crystal, and sealing agent can securely be deaerated.

With the pressure reduction based on the pressure reduction curve shown in FIG. 13C, the pressures in the second substrate and sealing agent may be reduced to “low” to “medium” reduced pressures, but the first substrate and liquid crystal are requested to be reduced to “medium” to “high” reduced pressures. Therefore, the second substrate and sealing agent are left to stand under a reduced pressure atmosphere higher than necessary.

Therefore, in a case where the first and second substrates are requested to be deaerated in the same chamber, even when the second substrate and sealing agent are left to stand under the high reduced pressure atmosphere, it is possible to deaerate the substrate based on the pressure reduction curve shown in FIG. 13C as long as disadvantages are not caused.

In the above-described embodiments, the first substrate 3 is applied the sealing agent 7, and the liquid crystal 14 is dropped/supplied. However, either one of the first and second substrates 3, 4 may be applied the sealing agent 7, and the liquid crystal may be dropped onto the other substrate. In this case, both the first and second substrates or only the substrate onto which the liquid crystal has been dropped may be left to stand under the predetermined reduced pressure atmosphere of the pressure reduction leaving device.

The liquid material disposed between one pair of substrates is not limited to the liquid crystal, and another liquid material may also be used. In short, any liquid material may be used as long as the material is charged between two substrates bonded to each other at a predetermined interval.

It is to be noted that as described above in the respective embodiments, in the present invention, a step of leaving the substrate under the predetermined reduced pressure atmosphere and the step of bonding one pair of substrates to each other may be carried out under the reduced pressure atmosphere under which at least either one of the chamber (space) and the pressure is different or at least one is the same.

Moreover, as shown in FIGS. 9 to 12, to maintain the pressure in the chamber to be constant within a set time, an upper-limit pressure P_{H} and lower-limit pressure P_{L} are set beforehand in the pressure control device with respect to a targeted pressure P. After the pressure detected in the pressure sensor is smaller than P_{H}, the exhaust adjustment valve is opened and the supply adjustment valve is closed until the pressure exceeds P_{L}. When the pressure exceeds P_{L}, the exhaust adjustment valve is closed and the supply adjustment valve is opened. Moreover, thereafter, the exhaust adjustment valve and the supply adjustment valve are controlled to open/close so as to maintain the pressure in the chamber between P_{H} and P_{L}. In this case, the pressure in the chamber can be maintained within a set range.

It is to be noted that in the sixth embodiment, the pressure reduction curve (pattern for changing the pressure in the chamber) is changed, that is, the pressure reduction curve is changed for each arrangement pattern of the liquid crystal in the cases where the amount of droplets per drop of the liquid crystal is decreased and the number of drops is increased and where the amount of droplets per drop is increased and the number of drops is decreased. This example has been described. However, the pressure reduction curve may also be changed for each arrangement pattern of the sealing agent. In this case, for example, in a case where an applying amount of the sealing agent is decreased, as compared with a case where the applying amount of the sealing agent is increased, a constitution is possible in which the degree of vacuum required for the deaeration is lowered and the leaving time is set to be short.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An assembly method for substrates, comprising:
an applying step of applying a sealing agent onto either one of two substrates;
a dropping step of dropping a predetermined amount of a liquid material onto either one of the two substrates;
a leaving step of leaving at least the substrate on which the liquid material has been dropped in the two substrates to stand under a reduced pressure atmosphere for a predetermined time; and
a bonding step of bonding the two substrates to each other under the reduced pressure atmosphere, after leaving at least the substrate on which the liquid material has been dropped under the reduced pressure atmosphere for the predetermined time.

2. The assembly method for the substrates according to claim 1, wherein the leaving step and the bonding step are carried out under the reduced pressure atmosphere under which at least one of a space and pressure differs.

3. The assembly method for the substrates according to claim 1, wherein the leaving step and the bonding step are carried out under the reduced pressure atmosphere under which at least one of a space and pressure is the same.

4. The assembly method for the substrates according to claim 1, further comprising: carrying out the leaving step and the bonding step under the reduced pressure atmosphere in different spaces; and conveying the substrate left to stand under the reduced pressure atmosphere in the leaving step to the space where the bonding step is carried out through the space under the reduced pressure atmosphere.

5. The assembly method for the substrates according to claim 1, further comprising: a step of heating at least one of the substrates before bonding the two substrates to each other.

6. The assembly method for the substrates according to claim 1, wherein the leaving step includes: leaving the substrate to stand under the reduced pressure atmosphere for the predetermined time and simultaneously heating the substrate at a predetermined temperature.

7. The assembly method for the substrates according to claim 1, wherein the leaving step includes: changing a pressure of a space where the substrate onto which the liquid material has been dropped is left to stand in a predetermined pattern.

8. The assembly method for the substrates according to claim 1, wherein the leaving step includes: changing a pressure of a space where the substrate onto which the liquid material has been dropped is left to stand in a predetermined pattern for each type of at least one of the substrate and the liquid material or the sealing agent disposed on the substrate.

9. The assembly method for the substrates according to claim 1, wherein the leaving step includes: changing a pressure of a space where the substrate onto which the liquid material has been dropped is left to stand in a predetermined pattern for each arrangement pattern of the liquid material or the sealing agent disposed on the substrate.

10. The assembly method for the substrates according to claim 1, wherein the leaving step includes: supplying an inactive gas, when raising a pressure of a space where the substrate is left to stand.

11. The assembly method for the substrates according to claim 1, wherein the leaving step includes: maintaining a pressure of a space where the substrate onto which the liquid material has been dropped is left to stand at a pressure set for each type of at least one of the substrate and the liquid material or the sealing agent disposed on the substrate.

12. The assembly method for the substrates according to claim 1, wherein the leaving step includes: reducing a pressure of a space where the substrate onto which the liquid material has been dropped is left to stand in a predetermined pattern;
and leaving the substrate to stand until the pressure reaches a predetermined pressure.

13. An assembly apparatus for substrates, comprising:
an applying device which applies a sealing agent onto either one of two substrates;
a dropping device which drops a predetermined amount of a liquid material onto either one of the two substrates;
a pressure reduction leaving device including a first chamber to leave at least the substrate on which the liquid material has been dropped to stand under a reduced pressure atmosphere for a predetermined time; and
a bonding device including a second chamber in which the two substrates are bonded to each other under the reduced pressure atmosphere, after leaving at least the substrate on which the liquid material has been dropped under the reduced pressure atmosphere for the predetermined time.

14. The assembly apparatus for the substrates according to claim 13, wherein the second chamber also serves as the first chamber.

15. The assembly apparatus for the substrates according to claim 14, further comprising: first pressure reduction means for reducing a pressure in the second chamber to a predetermined pressure; and second pressure reduction means for further reducing the pressure in the second chamber whose pressure has been reduced by the first pressure reduction means.

16. The assembly apparatus for the substrates according to claim 13, wherein the pressure reduction leaving device is connected to the bonding device via a transfer chamber which can convey the substrate left to stand under the reduced pressure atmosphere of the pressure reduction leaving device for the predetermined time to the bonding device without exposing the substrate to atmospheric air.

17. The assembly apparatus for the substrates according to claim 13, further comprising: heating means for heating at least one substrate at a predetermined temperature, before bonding the two substrates to each other.

18. The assembly apparatus for the substrates according to claim 13, further comprising: heating means, disposed in either one of the pressure reduction leaving device and the bonding device, for heating the substrate at a predetermined temperature.

19. The assembly apparatus for the substrates according to claim 13, further comprising: control means for changing a pressure in the first chamber in a predetermined pattern.

20. The assembly apparatus for the substrates according to claim 13, further comprising: control means for changing a pressure in the first chamber in a predetermined pattern for each type of at least one of the substrate and the liquid material or the sealing agent disposed on the substrate.

21. The assembly apparatus for the substrates according to claim 13, further comprising: control means for changing a pressure in the first chamber in a predetermined pattern for each arrangement pattern of the liquid material or the sealing agent disposed on the substrate.

22. The assembly apparatus for the substrates according to claim 13, further comprising: inactive gas supply means for supplying an inactive gas into the first chamber.

23. The assembly apparatus for the substrates according to claim 13, further comprising: means for maintaining a pressure in the first chamber at a pressure set for each type of at least one of the substrate and the liquid material or the sealing agent disposed on the substrate.

24. The assembly apparatus for the substrates according to claim 13, further comprising: control means for reducing a pressure in the first chamber in a predetermined pattern and leaving the substrate to stand until the pressure reaches a predetermined pressure.
